(19) United States
(12) Patent Application Publication
(10) Pub. No.: US 2024/0399763 A1
(43) Pub. Date: Dec. 5, 2024

(54) PRINTING APPARATUS AND PRINTING METHOD

(71) Applicant: SEIKO EPSON CORPORATION, Tokyo (JP)

(72) Inventors: Sandro ROBUSTELLI, Villa Guardia (IT); Ugo ZAROLI, Busto Arsizio (IT); Davide GATTI, Caronno Pertusella (IT); Kenji KOJIMA, FUJIMI-MACHI (JP); Shoji YAMAMOTO, MATSUMOTO-SHI (JP)

(21) Appl. No.: 18/676,592

(22) Filed: May 29, 2024

(30) Foreign Application Priority Data
Jun. 1, 2023 (JP) 2023-090727

(51) Int. Cl. B41J 2/505; B41J 2/14

(52) U.S. Cl. CPC B41J 2/5056; B41J 2/14201

(57) ABSTRACT

A printing apparatus includes a transport unit configured to transport a medium in a first direction, a carriage configured to move in a second direction intersecting the first direction, a first printing unit held by the carriage, and a second printing unit held by the carriage, the second printing unit being arranged at least one of a position further upstream and a position further downstream than a position of the first printing unit, a length of the second printing unit in the first direction is shorter than a length of the first printing unit in the first direction, and the second printing unit is caused to be available in a multi-pass mode.

The present application is based on, and claims priority from JP Application Serial Number 2023-090727, filed Jun. 1, 2023, the disclosure of which is hereby incorporated by reference herein in its entirety.

### BACKGROUND

### 1. Technical Field

The present disclosure relates to a printing apparatus and a printing method by using the printing apparatus.

### 2. Related Art

In the related art, there is known a printing apparatus that performs second printing for covering clear ink, glossy ink, or the like on first printing by color printing. For example, JP 2023-63795 A discloses a liquid droplet ejecting apparatus including a first head for ejecting color ink and a second head for ejecting clear ink or the like.

According to FIG. 2 and its description in JP 2023-63795 A, it is presumed that the first head and the second head are the same ejecting head, and the first head and the second head are arranged side by side along a sub-scanning direction of a medium to be printed such as a fabric. That is, the first head and the second head are arranged side by side in the sub-scanning direction, and the same ejecting head as the first head having a high resolution for color printing is used as the second head for post-processing.

However, in the liquid droplet ejecting apparatus disclosed in JP 2023-63795 A, since two large first heads for color printing are arranged side by side in the sub-scanning direction, there is a problem that the printing head becomes large and the printing apparatus becomes large.

### SUMMARY

A printing apparatus according to an aspect of the present application includes a transport unit configured to transport a medium in a first direction, a carriage configured to move in a second direction intersecting the first direction, a first printing unit held by the carriage, and a second printing unit held by the carriage, the second printing unit being arranged at least one of a position further upstream and a position further downstream than a position of the first printing unit, a length of the second printing unit in the first direction is shorter than a length of the first printing unit in the first direction, and the second printing unit is caused to be available in a multi-pass mode.

A printing method according to an aspect of the present application is a printing method by using a printing apparatus, the printing apparatus including a control unit, a transport unit configured to transport a medium in a first direction, a carriage configured to move in a second direction intersecting the first direction, a first printing unit held by the carriage, and a second printing unit held by the carriage, the second printing unit being arranged at least one of a position further upstream and a position further downstream than a position of the first printing unit, a length of the second printing unit in the first direction is shorter than a length of the first printing unit in the first direction, and the control unit causes the second printing unit to be available when a print mode of the printing apparatus is a multi-pass mode.

### BRIEF DESCRIPTION OF THE DRAWING

FIG. 1 is a side view of a printing apparatus according to Embodiment 1.

FIG. 2 is a functional block diagram of the printing apparatus.

FIG. 3 is a plan view of a printing unit.

FIG. 4 is a plan view of a printing head viewed from below.

FIG. 5 is an enlarged plan view of a second printing unit.

FIG. 6 is a perspective view of an ejecting head.

FIG. 7 is a side cross-sectional view illustrating a schematic configuration of a solenoid valve.

FIG. 8 is a side cross-sectional view of another mode illustrating the schematic configuration of the solenoid valve.

FIG. 9 is an enlarged plan view of a second printing unit according to Embodiment 2.

FIG. 10 is a plan view of a printing unit according to Embodiment 3.

### DESCRIPTION OF EMBODIMENTS

### Embodiment 1

### Overview of Printing Apparatus

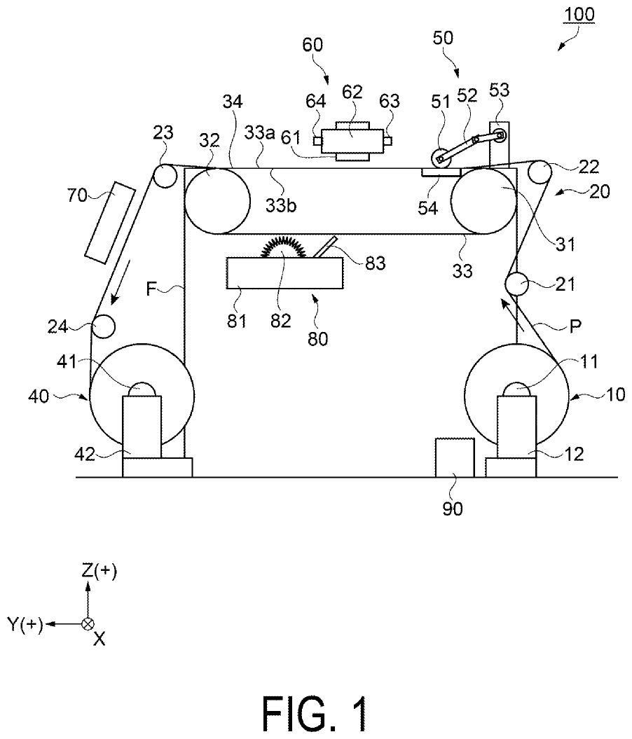

FIG. 1 is a side view of a printing apparatus according to the present embodiment.

A printing apparatus 100 according to the present embodiment illustrated in FIG. 1 is an ink-jet printing apparatus that performs textile printing by printing a pattern, an image, or the like on a medium P being long such as a fabric. Note that, an X-axis, a Y-axis, and a Z-axis are illustrated in each of the drawings as three axes orthogonal to each other. In the present embodiment, a vertically upward direction is set to a Z positive direction, a transport direction of the medium P is set to a Y positive direction, and a width direction of the medium P is set to an X positive direction. Further, the Z positive direction is also referred to as an upward direction, and a Z negative direction is also referred to as a downward direction. The X positive direction and an X negative direction are also collectively referred to as an X-axis direction. The same applies to the Y-axis, and the Z-axis. Further, the X-axis direction corresponds to a main scanning direction, and the Y positive direction corresponds to a sub-scanning direction. Note that the sub-scanning direction is also referred to as a first direction, and the main scanning direction is also referred to as a second direction.

As illustrated in FIG. 1, the printing apparatus 100 includes a medium transport unit 20, a medium close-contact unit 50, a printing unit 60, a drying unit 70, a cleaning unit 80, and the like. Furthermore, the printing apparatus 100 includes a control unit 90 configured to control these units. Each unit of the printing apparatus 100 is attached to a frame F.

The medium transport unit 20 is a transport unit that transports the medium P along a transport path. The medium transport unit 20 includes a medium supply unit 10, transport rollers 21 to 24, a transport belt 33, a belt-rotating roller 31, a belt-driving roller 32, and a medium collection unit 40. First, the transport path for the medium P from the medium supply unit 10 to the medium collection unit 40 will be described.

The medium supply unit 10 supplies the medium P to the transport belt 33. As the medium P, there can be used, for example, natural fibers, cotton, silk, hemp, mohair, wool, cashmere, regenerated fibers, synthetic fibers, nylon, polyurethane, polyester, and woven fabrics fabricated by mixed spinning of these fibers. In the present embodiment, these woven fabrics are referred to as fabrics. Alternatively, non-woven fabrics may be used. To the fabrics or the non-woven fabrics, a pretreatment agent for promoting color developability and fixability may be applied.

The medium supply unit 10 includes a supply shaft unit 11 around which the medium P having a belt shape is wound in a roll shape, a bearing unit 12 that detachably and rotatably supports both ends of the supply shaft unit 11 having a cylindrical shape, and a rotation driving unit including a motor that rotationally drives the supply shaft unit 11. When the rotation driving unit is rotationally driven and the supply shaft unit 11 rotates, the medium P is fed out. The transport rollers 21 and 22 relay the medium P fed out from the medium supply unit 10 to the transport belt 33.

The transport belt 33 transports the medium P facing the printing unit 60 in the sub-scanning direction. The transport belt 33 has a belt shape including both end portions coupled to each other and is formed in an endless manner, and the transport belt 33 is hung between the belt-rotating roller 31 and the belt-driving roller 32. The transport belt 33 is held in a state where a predetermined tension is applied thereto. A front surface 33a of the transport belt 33 is provided with an adhesive layer 34 onto which the medium P adheres. The transport belt 33 supports (holds) the medium P brought into close contact with the adhesive layer 34 by the medium close-contact unit 50, which will be described later. This allows stretchable fabrics and the like to be handled as the medium P.

The belt-rotating roller 31 and the belt-driving roller 32 are provided at an inner side of the transporting belt 33, and support an inner peripheral surface 33b of the transport belt 33. The belt-driving roller 32 includes a rotation driving unit that rotationally drives the belt-driving roller 32. When the belt-driving roller 32 is rotationally driven and the transport belt 33 rotationally moves, the belt-rotating roller 31 is driven to rotate. Accordingly, the medium P supported by the transport belt 33 is transported in the sub-scanning direction, and an image is formed on the medium P by the printing unit 60 provided between the belt-rotating roller 31 and the belt-driving roller 32.

Note that a configuration in which a support unit configured to support the transport belt 33 is provided between the belt-rotating roller 31 and the belt-driving roller 32 may be applied. Moreover, the transport belt 33 provided with the adhesive layer 34 to be closely contacted with the medium P has been described, but may be an electrostatic attraction type transport belt configured to attract a medium due to static electricity.

The transport roller 23 peels off the medium P on which the image is formed, from the transport belt 33. The transport rollers 23 and 24 relay the peeled-off medium P to the medium collection unit 40.

The medium collection unit 40 collects the medium P. The medium collection unit 40 includes a winding shaft unit 41 that winds the medium P in a roll shape, a bearing unit 42 that detachably and rotatably supports both ends of the winding shaft unit 41 having a cylindrical shape, and a rotation driving unit that rotationally drives the winding shaft unit 41. The rotation driving unit is rotationally driven and the winding shaft unit 41 rotates, which winds the medium P.

Next, each unit provided along the transport path of the medium P will be described.

The medium close-contact unit 50 is provided upstream of the printing unit 60 and causes the medium P supplied onto the transport belt 33 to come into close contact with the adhesive layer 34. The medium close-contact unit 50 includes a press roller 51 formed in a columnar shape, a roller support unit 52 that rotatably supports both ends of the press roller 51, a roller receiving unit 54 that receives a load of the press roller 51 through the transport belt 33, and a press roller driving unit 53 that drives the press roller 51. The press roller driving unit 53 moves the press roller 51 in the sub-scanning direction and a direction opposite to the sub-scanning direction. Accordingly, the medium P is pressed by the load of the press roller 51 and comes into close contact with the adhesive layer 34.

The printing unit 60 is arranged above the transport belt 33 and performs printing on the medium P on the transport belt 33.

The printing unit 60 includes a printing head 61, a carriage 62 mounted with the printing head 61, and guide rails 63 and 64 that support the carriage 62. Note that details of the printing head 61 will be described later.

The guide rails 63 and 64 are rails extending along the X-axis direction and supports the carriage 62 so as to be capable of reciprocating in the main scanning direction.

The printing unit 60 includes a movement mechanism that moves the carriage 62 and a power source that drives the movement mechanism. As the movement mechanism, for example, a mechanism including a combination of a ball screw and a ball nut, a linear guide mechanism, or the like may be employed. As the power source, for example, a variety of motors such as a stepping motor, a servo motor, and a linear motor may be employed.

The drying unit 70 is provided upstream of the winding shaft unit 41 and dries the medium P peeled off from the transport belt 33. The drying unit 70 includes, for example, an IR heater, and dries ink permeated into the medium P in a short period of time by driving the IR heater. Thus, the printed medium P can be wound onto the winding shaft unit 41.

The cleaning unit 80 is arranged between the belt-driving roller 32 and the belt-rotating roller 31, and cleans the front surface 33a of the transport belt 33 from below after the medium P is peeled off. The cleaning unit 80 includes a cleaning tank 81, a cleaning roller 82 having a cylindrical shape, a blade 83, and a rotation driving unit that rotationally drives the cleaning roller 82. The cleaning tank 81 is a tank that stores a cleaning liquid. As the cleaning liquid, for example, water or a water-soluble solvent such as alcohol aqueous solution may be used, and a surfactant agent and an anti-foaming agent may be added as necessary.

The cleaning roller 82 is rotatably supported inside the cleaning tank 81 such that an upper portion thereof protrudes from the cleaning tank 81. The cleaning roller 82 is rotated, and the cleaning roller 82 and the transport belt 33 slide. This removes ink adhering onto the transport belt 33, fibers of a fabric as the medium P, and the like.

The blade 83 is positioned downstream of the cleaning roller 82 and is provided inside the cleaning tank 81 such that an upper end thereof protrudes from the cleaning tank 81. The transport belt 33 and the blade 83 slide along with the rotation of the transporting belt 33, which removes the cleaning liquid remaining on the front surface 33a of the transport belt 33.

### Functional Block Configuration of Printing Apparatus

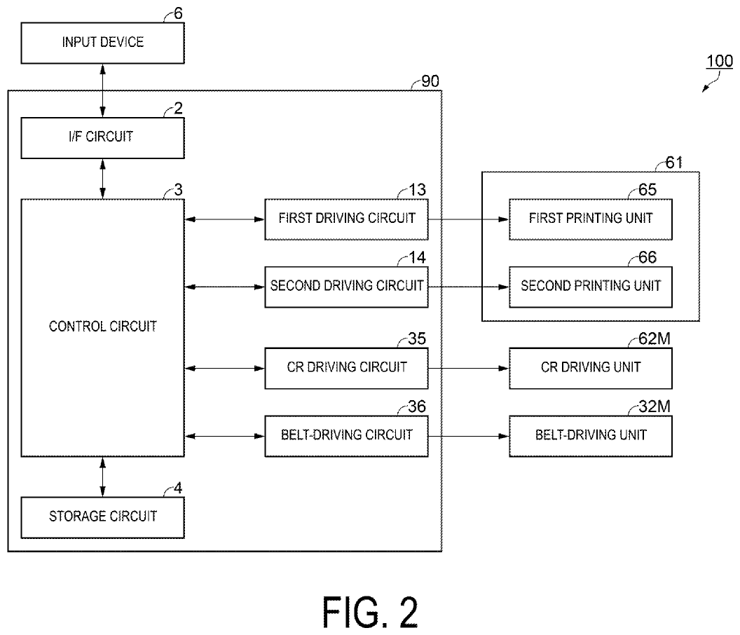

FIG. 2 is a functional block diagram of the printing apparatus.

The printing apparatus 100 includes the control unit 90 configured to control the units included in the printing apparatus 100.

An input device 6 that supplies print data is coupled to the control unit 90. The input device 6 is, for example, a laptop personal computer. Note that the input device 6 may be any device capable of supplying print data, and may be, for example, a desktop computer, a tablet terminal, or a portable terminal.

The print data includes image data defining patterns, images, and the like, print parameters defining optimum conditions for printing the image data, and the like. The print parameters also include the number of times of multi-pass that defines the number of times of overlapping printing for printing with high quality.

The control unit 90 includes an interface circuit 2, a control circuit 3, a storage circuit 4, a first driving circuit 13, a second driving circuit 14, a CR driving circuit 35, a belt-driving circuit 36, and the like.

The interface unit 2 is an interface circuit that transmits/receives image data or the like between the input device 6 and the control circuit 3.

The control circuit 3 includes one or a plurality of processors, and integrally controls operations of the printing apparatus 100 by operating in accordance with a control program stored in the storage circuit 4.

The storage circuit 4 includes a random access memory (RAM), and a read only memory (ROM). The RAM is used to temporarily store various types of data, and the like, and the ROM stores the control program to be used for controlling operations of the printing apparatus 100, accompanying data, and the like. The control program stores a boot program for instructing an order and contents of processing in activating the printing apparatus 100, a print program for specifying an order and contents of processing in performing printing in a multi-pass mode, and the like. The accompanying data includes correlation data that defines an ejection amount of second ink according to the number of scanning passes.

The printing head 61 includes a first printing unit 65 and a second printing unit 66. As will be described in detail later, the first printing unit 65 ejects first ink constituted by color ink, and the second printing unit 66 ejects the second ink such as clear ink.

The first driving circuit 13 is a driving circuit that drives and controls the ejection of the first ink by an ejecting head of the first printing unit 65.

The second driving circuit 14 is a driving circuit that drives and controls the ejection of the second ink by an ejecting head of the second printing unit 66.

The CR driving circuit 35 causes the carriage 62 to reciprocate in the main scanning direction by rotationally driving a motor attached to a CR driving unit 62M that is a power source of the carriage 62. In other words, the carriage 62 moves in the main scanning direction as the second direction intersecting the first direction as the sub-scanning direction.

The belt-driving circuit 36 rotates the belt-driving roller 32 to drive the transport belt 33 by rotationally driving a motor attached to a belt-driving unit 32M that is a rotation driving unit of the belt-driving roller 32.

The control circuit 3 performs printing on the medium P based on image data by performing a printing operation in which main scanning in which the carriage 62 is reciprocated while ink is being ejected from the ejecting head by controlling the printing head 61 and sub-scanning in which the medium P is transported in the transport direction by controlling the belt-driving roller 32 are alternately repeated by the respective units described above.

### Configuration of Printing Head

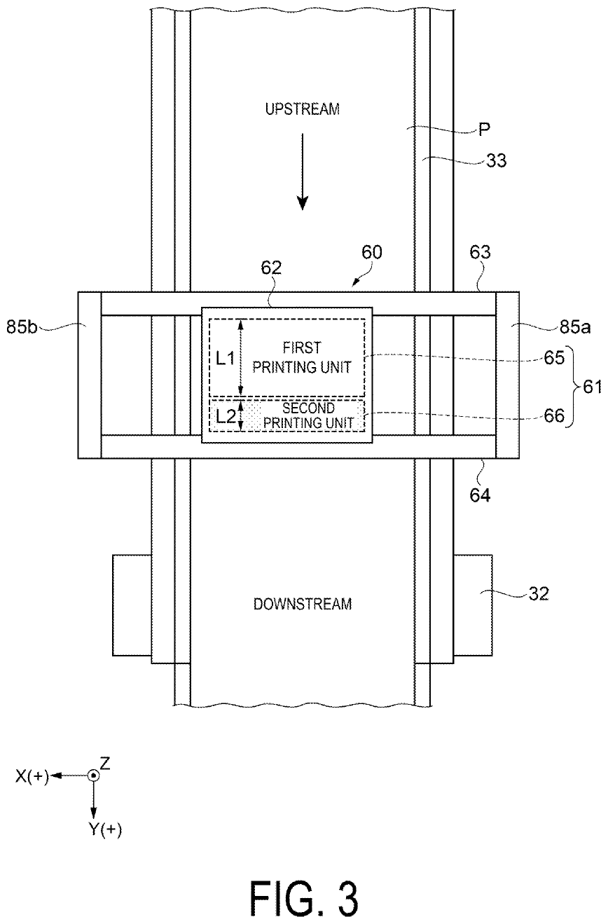

FIG. 3 is a plan view of the printing unit.

FIG. 3 is a plan view of the printing unit 60 viewed from above, and the carriage 62 having a rectangular shape is supported by a pair of guide rails 63 and 64. The guide rails 63 and 64 extend along the X-axis direction. The guide rails 63 and 64 are spaced apart from each other in the Y-axis direction, and the carriage 62 is provided so as to straddle both the guide rails.

The guide rails 63 and 64 are bridged between a pair of frame portions 85a and 85b vertically provided outside the transport belt 33. The carriage 62 is provided so as to be capable of reciprocating in the main scanning direction that is an extending direction of the guide rails 63 and 64 by using, for example, a mechanism in which a ball screw and a ball nut are combined.

In FIG. 3, the printing head 61 positioned at the lower side of the carriage 62 is transparently illustrated. As illustrated in FIG. 3, the printing head 61 includes the first printing unit 65 and the second printing unit 66. The first printing unit 65 is positioned upstream in the transport direction of the medium P, and the second printing unit 66 is positioned downstream. In other words, the first printing unit 65 and the second printing unit 66 are held by the carriage 62. Then, the second printing unit 66 is arranged further downstream than the first printing unit 65.

In the transport direction of the medium P, a length L1 of the first printing unit 65 is longer than a length L2 of the second printing unit 66. That is, in the sub-scanning direction, the length L1 of the first printing unit 65 is longer than the length L2 of the second printing unit 66. In other words, the length L2 of the second printing unit in the first direction is shorter than the length L1 of the first printing unit in the first direction.

### Configuration of First Printing Unit

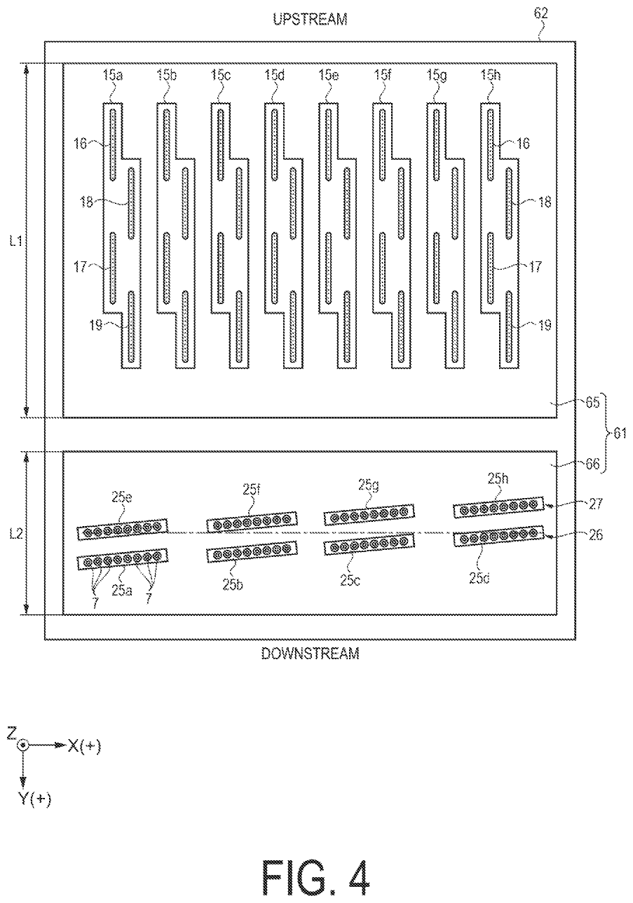

FIG. 4 is a plan view of the printing head viewed from below.

As illustrated in FIG. 4, the first printing unit 65 includes eight ejecting heads 15a to 15h arranged side by side in the main scanning direction. Note that a content common to the respective ejecting heads 15 will be described without adding a branch number.

The ejecting head 15 is provided with four nozzle arrays 16, 17, 18, and 19. The nozzle array 16 is a single nozzle column extending in the sub-scanning direction, and the number of nozzles is 800, for example. The nozzle array 17 is the same nozzle column as that of the nozzle array 16, and is arranged in the same column as that of the nozzle array 16 so as to be separated from the nozzle array 16 in the sub-scanning direction.

The nozzle array 18 is the same nozzle column as that of the nozzle array 16, and is arranged so as to be separated from the nozzle array 16 in the X positive direction. The nozzle array 18 is arranged between the nozzle array 16 and the nozzle array 17 in the sub-scanning direction.

The nozzle array 19 is the same nozzle column as that of the nozzle array 16, and is arranged in the same column as that of the nozzle array 18 so as to be separated from the nozzle array 18 in the sub-scanning direction.

The nozzle array 16 and the nozzle array 18 are arranged so as to overlap with each other such that the plurality of nozzles scan the same track when the ejecting head 15 moves in the main scanning direction. Similarly, the nozzle array 18 and the nozzle array 17, and the nozzle array 17 and the nozzle array 19 are arranged so as to overlap with each other such that the plurality of nozzles scan the same track when the ejecting head 15 moves in the main scanning direction.

Accordingly, a band length of the ejecting head 15 is a length between an end portion nozzle positioned upstream of the nozzle array 16 and an end portion nozzle positioned downstream of the nozzle array 19 in the sub-scanning direction. In a preferred example, printing at a resolution of 600 dpi can be performed.

The ejecting head 15 is an ink-jet type ejecting head. In a preferred example, a piezoelectric type is employed in which a part of a wall surface in a pressure chamber communicating with a nozzle is provided so as to be deformable, a drive signal is applied to a piezoelectric element to contract the piezoelectric element, the wall surface is bent due to the contraction, and ink in the pressure chamber is ejected from the nozzle as ink droplets. Note that the present disclosure is not limited to the piezoelectric type, and it is sufficient that the ink-jet type is employed. For example, a thermal type may be used in which a liquid filled in a pressure chamber is heated by applying a current to a resistance element such as a heater, and the thermal energy is transferred to the liquid to eject the liquid.

In a preferred example, eight colors of ink are supplied to the eight ejecting heads 15a to 15h. Note that the ink to be supplied to the first printing unit 65 is referred to as the first ink. As a type of the first ink, an optimum type is selected according to the material of the medium P and the like, and examples thereof include reactive dye ink, disperse dye ink, acid dye ink, pigment ink, and the like. Examples of ink colors of the reactive dye ink include black, cyan, magenta, yellow, gray, red, blue, and orange.

According to such a first printing unit 65, full-color printing with a high definition can be performed on the medium P according to the image data.

### Configuration of Second Printing Unit

As illustrated in FIG. 4, the second printing unit 66 includes an ejecting head row 26 and an ejecting head row 27 that are arranged in two rows and that are positioned upstream and downstream in the sub-scanning direction.

The ejecting head row 26 positioned downstream is constituted by four ejecting heads 25a to 25d. The ejecting head row 27 positioned upstream is constituted by four ejecting heads 25e to 25h. Note that a content common to the respective ejecting heads 25 will be described without adding a branch number.

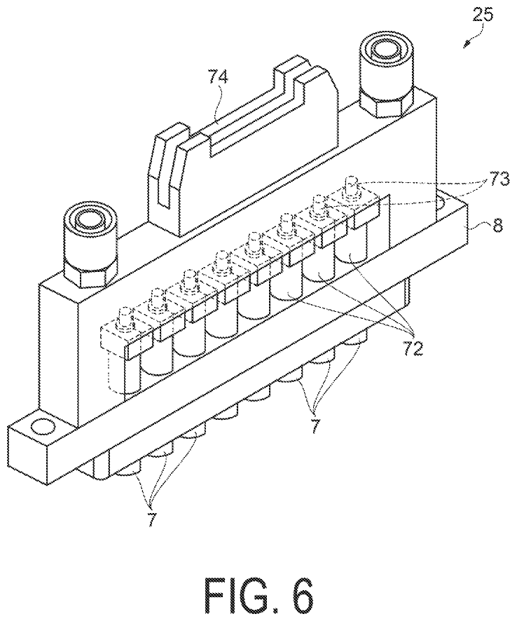

The ejecting head 25 has an elongated rectangular shape and includes eight nozzles 7 arranged along a long side thereof. In the preferred example, the nozzle 7 is a nozzle of a solenoid valve 72 (FIG. 6). In other words, the second printing unit 66 includes a solenoid valve type of the ejecting head 25 including a plurality of solenoid valves 72.

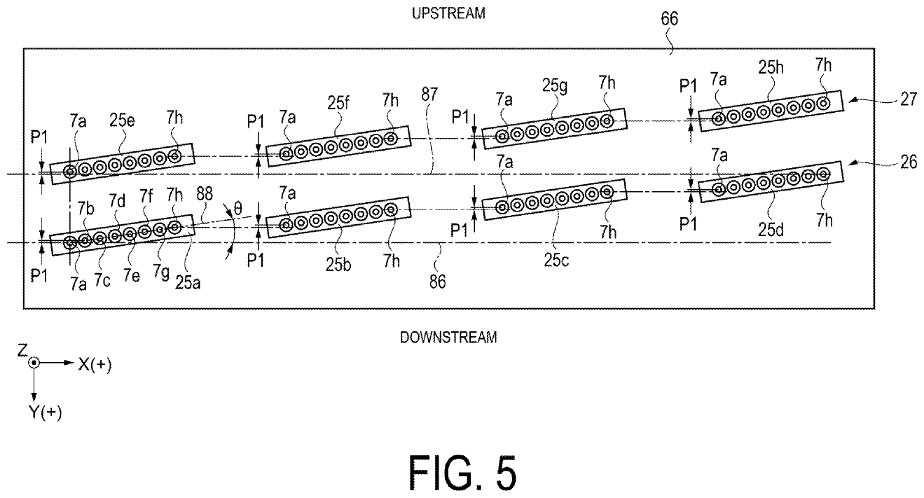

FIG. 5 is an enlarged plan view of the second printing unit.

The ejecting head 25a of the ejecting head row 26 is arranged in an inclined manner with respect to a line segment 86 parallel to the X-axis. Specifically, a line segment 88 passing through centers of a nozzle 7a at one end and a nozzle 7h at the other end has an inclination of an angle θ with respect to the line segment 86.

The angle θ is an angle at which an arrangement pitch in the sub-scanning direction between the nozzle 7a and a nozzle 7b is a pitch P1. Arrangement pitches in the sub-scanning direction between the nozzle 7b and a nozzle 7c, between the nozzle 7c and a nozzle 7d, between the nozzle 7d and a nozzle 7e, between the nozzle 7e and a nozzle 7f, between the nozzle 7f and a nozzle 7g, and between the nozzle 7g and the nozzle 7h are also the pitch P1. Note that the pitch P1 is, for example, about 0.84 mm, but is not limited thereto.

Similarly, the ejecting heads 25b, 25c, and 25d are arranged at the inclination of the angle θ with respect to the line segment 86. In other words, the ejecting head 25 is arranged in an inclined manner with respect to the second direction.

The ejecting head 25b is arranged at the X positive side of the ejecting head 25a. The nozzle 7a at one end of the ejecting head 25b is arranged at a position shifted from the nozzle 7h at the other end of the ejecting head 25a by the pitch P1 in the Y negative direction.

The ejecting head 25c is arranged at the X positive side of the ejecting head 25b. The nozzle 7a at one end of the ejecting head 25c is arranged at a position shifted from the nozzle 7h at the other end of the ejecting head 25b by the pitch P1 in the Y negative direction.

The ejecting head 25d is arranged at the X positive side of the ejecting head 25c. The nozzle 7a at one end of the ejecting head 25d is arranged at a position shifted from the nozzle 7h at the other end of the ejecting head 25c by the pitch P1 in the Y negative direction.

The ejecting head row 27 has the same configuration as that of the ejecting head row 26, and is arranged to be separated from the ejecting head row 26 in the Y negative direction. The nozzle 7a at one end of the ejecting head 25e in the ejecting head row 27 is arranged at a position shifted from the nozzle 7h at the other end of the ejecting head 25d in the ejecting head row 26 by the pitch P1 in the Y negative direction.

A band length of the second printing unit 66 is a length from the nozzle 7a at one end of the ejecting head 25a of the ejecting head row 26 to the nozzle 7h at the other end of the ejecting head 25h of the ejecting head row 27 in the sub-scanning direction. In a preferred example, printing at a resolution of 32 dpi can be performed. Note that since it is sufficient that the second ink covers, at a predetermined thickness, the surface printed with the first ink, a high resolution such as that of the first ink is not necessary, and this resolution is sufficient.

With such a configuration, the length L2 (FIG. 4) of the second printing unit in the sub-scanning direction can be made shorter than the length L1 of the first printing unit. Specifically, the length L2 of the second printing unit can be less than or equal to half the length L1 of the first printing unit.

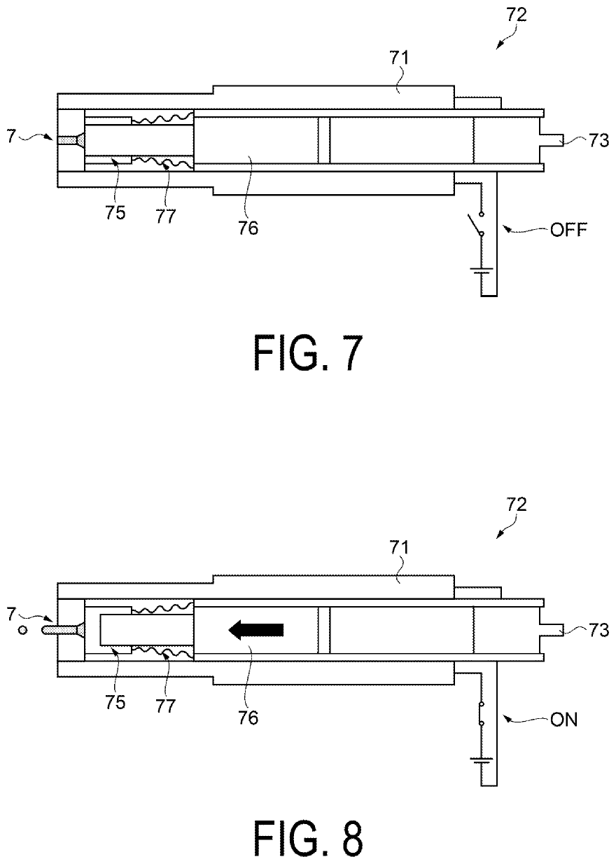

FIG. 6 is a perspective view of the ejecting head. FIG. 7 is a side cross-sectional view illustrating a schematic configuration of the solenoid valve. FIG. 8 is a side cross-sectional view of another mode illustrating the schematic configuration of the solenoid valve. As illustrated in FIG. 6, the ejecting head 25 includes eight solenoid valves 72 each of which has a cylindrical shape in a housing 8 having an elongated rectangular shape. A supply port 73 through which the second ink is supplied is provided at a side of the solenoid valve 72 opposite to the nozzle 7. A tube is coupled to the supply port 73, and the second ink is supplied through the tube.

A coupler 74 for electrical coupling is provided at a side of the ejecting head 25 opposite to the nozzle 7. A drive signal from the control unit 90 is applied to each solenoid valve 72 via the coupler 74.

As illustrated in FIG. 7, the solenoid valve 72 is constituted by a housing 71, the nozzle 7, a shutter 75, a spring 77, an actuator 76, and the like.

The housing 71 is, for example, a cylindrical member made of metal. An actuator 76 having a cylindrical shape is arranged in the housing 71. The nozzle 7 is provided at one end of the housing 71.

The shutter 75 and the spring 77 are provided between the nozzle 7 and the actuator 76. Note that in a preferred example, a coil spring is used as the spring 77.

The actuator 76 is, for example, an electromagnetic actuator, and can open and close the shutter 75 in accordance with a drive signal. Alternatively, a piezoelectric actuator may be used.

FIG. 7 illustrates a state in which no drive signal is applied. In this state, as illustrated in FIG. 7, since the shutter 75 is closed due to a biasing force of the spring 77, ink is not ejected from the nozzle 7.

FIG. 8 illustrates a state in which the drive signal has been applied. In this state, as illustrated in FIG. 8, the actuator 76 is activated due to the drive signal, the shutter 75 is opened against the biasing force of the spring 77, and ink is ejected at an amount corresponding to the drive signal from the nozzle 7.

In a preferred example, clear ink or glossy ink is used as the second ink to be ejected from the second printing unit 66. Note that the second ink is also referred to as a functional liquid.

Resin ink can be used as the clear ink. As a type of resin, for example, a polyester-based resin, an acrylic-based resin, a polyurethane-based resin, or the like can be used. Pigments, additives, and the like may be appropriately added to these resins.

Examples of the glossy ink include metallic ink containing components of a pigment, a resin, a diluent, and the like as main components, pearl ink containing components of a pigment, a resin, a diluent, and the like as main components, rainbow ink that is a special interference ink containing components of a pigment, a resin, a diluent, and the like as main components and obtaining an interference effect by adjusting a size of the pigment and a manufacturing process, and glossy ink containing components of a resin, a pigment, an additive, and the like as main components and usually adding a lubricant and a leveling agent to improve a gloss.

### Procedure of Printing

Reference is now made back to FIG. 4.

In a preferred example, the printing head 61 is set to eject the second ink at a predetermined amount by one time of scanning pass at the second printing unit 66 onto a portion printed by four times of scanning pass by using the first ink at the first printing unit 65. Note that the present disclosure is not limited to this setting, and the ejection amount of the second ink may be controlled according to the number of times of multi-pass. Specifically, when printing at the first printing unit 65 is in a single-pass mode, the second printing unit 66 does not eject the second ink, and on the other hand, ejects the second ink in the multi-pass mode.

Further, the second printing unit 66 reduces the ejection amount for one scanning pass as the number of scanning passes increases. For example, when the first printing unit 65 performs eight scanning passes of printing, the amount of ink to be ejected by the second printing unit 66 for one scanning pass is set to about ⅛. In other words, when the printing mode of the printing apparatus 100 is the multi-pass mode, the control unit 90 brings the second printing unit 66 into an available state. In addition, the second printing unit 66 decreases the ejection amount for one pass as the number of scanning passes increases. Note that these controls are performed by the control unit 90 executing the print program in the storage circuit 4 based on the print data received from the input device 6.

As described above, the printing apparatus 100 according to the present embodiment and the printing method thereof can achieve the following advantages.

The printing apparatus 100 includes the medium transport unit 20 configured to transport the medium P in the first direction, the carriage 62 configured to move in the second direction intersecting the first direction, the first printing unit 65 held by the carriage 62, and the second printing unit 66 held by the carriage 62, the second printing unit 66 being arranged further downstream than the first printing unit 65, the length L2 of the second printing unit 66 in the first direction is shorter than the length L1 of the first printing unit 65 in the first direction, and the second printing unit 66 is caused to be available in the multi-pass mode.

According to this configuration, the printing apparatus 100 includes the second printing unit 66 for the second ink having a length shorter than that of the first printing unit 65 for color printing in the sub-scanning direction. Thus, since the two large first heads for color printing are arranged in the sub-scanning direction, the printing head 61 and the apparatus configuration can be reduced in size unlike the known liquid droplet ejecting apparatus in which the printing head and apparatus have been increased in size.

As a result, it is possible to provide the printing apparatus 100 being capable of overlapping printing of a plurality of types of ink and having a small size.

In addition, the second printing unit 66 includes the solenoid valve type of the ejecting head 25 including a plurality of solenoid valves 72.

Since the resolution of the second ink in printing does not need to be as high as that of the first ink, the simple solenoid valve type can be adopted.

In addition, the ejecting head 25 is arranged in an inclined manner with respect to the second direction.

According to this configuration, the length L2 of the second printing unit 66 in the first direction can be configured to be short.

In addition, the second printing unit 66 decreases the ejection amount for one pass as the number of scanning passes increases.

According to this, since the ejection amount of the second ink is managed to be an appropriate amount even when the number of scanning passes increases, the ejection amount is prevented from becoming excessively large.

The printing method by using the printing apparatus 100 includes the control unit 90, the medium transport unit 20 configured to transport the medium P in the first direction, the carriage 62 configured to move in the second direction intersecting the first direction, the first printing unit 65 held by the carriage 62, the second printing unit 66 held by the carriage 62, and the second printing unit 66 being arranged further downstream than the first printing unit 65, the length L2 of the second printing unit 66 in the first direction is shorter than the length L1 of the first printing unit 65 in the first direction, and the control unit 90 causes the second printing unit 66 to be available when the printing mode of the printing apparatus 100 is the multi-pass mode.

According to this configuration, the printing apparatus 100 includes the second printing unit 66 for the second ink having a length shorter than that of the first printing unit 65 for color printing in the sub-scanning direction. Thus, since the two large first heads for color printing are arranged in the sub-scanning direction, the printing head 61 and the apparatus configuration can be reduced in size unlike the known liquid droplet ejecting apparatus in which the printing head and apparatus have been increased in size.

Furthermore, since printing by using the second printing unit 66 is performed in the multi-pass mode in which the overlapping printing of the second ink is required, operation efficiency is excellent.

As a result, it is possible to provide the printing apparatus 100 being capable of overlapping printing with a plurality of types of ink and having a small size and excellent operation efficiency.

### Embodiment 2

### Another Aspect of Second Printing Unit

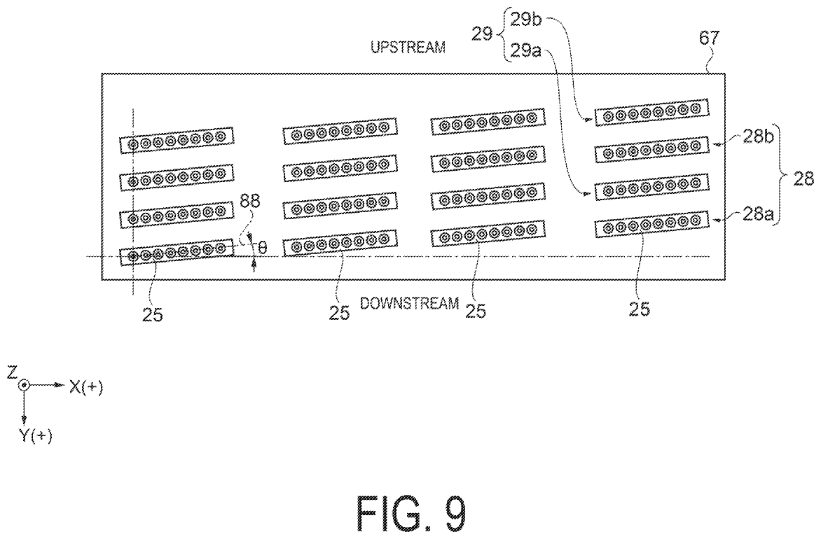

FIG. 9 is an enlarged plan view of a second printing unit according to Embodiment 2, and corresponds to FIG. 5.

In the above-described embodiment, the second printing unit 66 has been described as including the two ejecting head rows 26 and 27 arranged in the sub-scanning direction, but the present disclosure is not limited thereto, and a plurality of head pairs may be provided. The same constituent portions as those in the above-described embodiment are given the same reference signs, and overlapping description thereof will be omitted.

The second printing unit 67 according to the present embodiment includes two head pairs each of which includes two ejecting head rows. The head pair 28 is constituted by an ejecting head row 28a and an ejecting head row 28b. The head pair 29 is constituted by an ejecting head row 29a and an ejecting head row 29b. The ejecting head rows 28a and 28b and the ejecting head rows 29a and 29b have the same configuration as that of the ejecting head row 26 according to Embodiment 1. Note that the head pairs 28 and 29 are also referred to as the second printing unit. In other words, a plurality of head pairs 28 and 29 as the second printing unit are arranged in the second direction.

As illustrated in FIG. 9, the ejecting head row 28a, the ejecting head row 29a, the ejecting head row 28b, and the ejecting head row 29b are arranged in this order from downstream to upstream.

As described above, alternately arranging the ejecting head rows of the head pairs 28 and 29 makes it possible to shorten the length in the sub-scanning direction and to eject two different types of functional liquids.

Note that the arrangement of the ejecting head rows of the head pairs 28 and 29 is not limited to the alternate arrangement, and the head pair 28 and the head pair 29 may be arranged in this order from downstream to upstream. In this case, the ejecting head rows are arranged in the order of the ejecting head rows 28a and 28b and the ejecting head rows 29a and 29b from downstream to upstream. Even with this configuration, two different types of functional liquids can be ejected.

As described above, the printing apparatus 100 according to the present embodiment can achieve the following advantages.

A plurality of second printing units 67 are arranged in the second direction. Specifically, the second printing unit 67 includes the head pair 28 and the head pair 29.

According to this configuration, even when a plurality of head pairs are provided in the sub-scanning direction, a length of the second printing unit 67 in the sub-scanning direction can be configured to be shorter than the length L1 of the first printing unit 65, and different types of functional liquids can be ejected.

As a result, it is possible to provide the printing apparatus 100 being capable of overlapping printing of a plurality of types of ink and having a small size.

### Embodiment 3

### Configuration Including Third Printing Unit

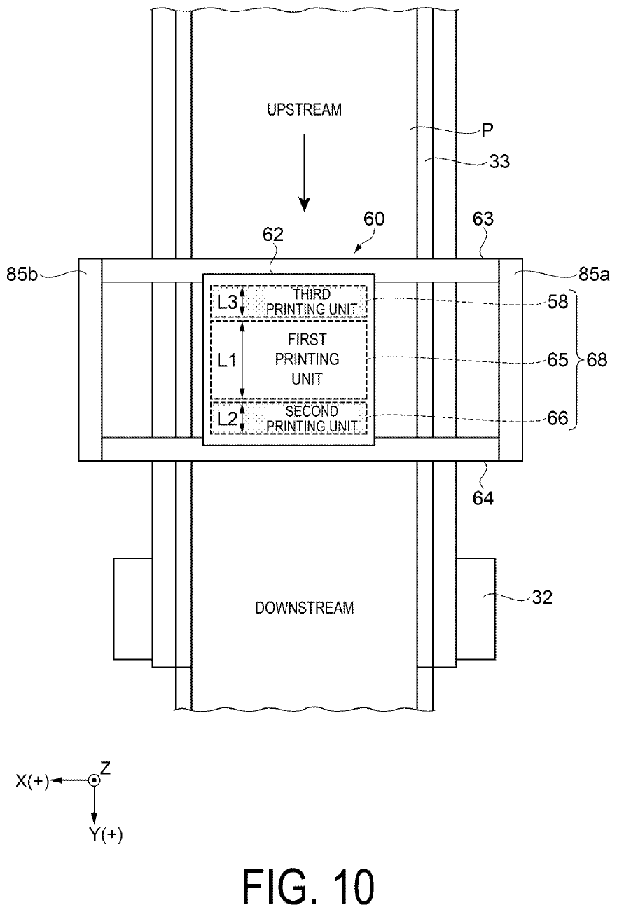

FIG. 10 is a plan view of a printing unit according to Embodiment 3, and corresponds to FIG. 3.

In the embodiment described above, the printing head 61 has been described as including two printing units of the first printing unit 65 and the second printing unit 66, but is not limited thereto, and may further include a third printing unit as a second printing unit. The same constituent portions as those in the above-described embodiment are given the same reference signs, and overlapping description thereof will be omitted.

As illustrated in FIG. 10, the printing head 68 according to the present embodiment includes a third printing unit 58 in addition to the first printing unit 65 and the second printing unit 66. The third printing unit 58 is the same solenoid valve type of a printing unit as that of the second printing unit 66, and is provided upstream of the first printing unit 65.

A length L3 of the third printing unit 58 in the sub-scanning direction is the same as the length L2 of the second printing unit 66. Thus, even with a configuration in which the third printing unit 58 and the second printing unit 66 are provided in front of and behind the first printing unit 65, the printing head 68 can be configured to be small. Note that although the printing head 68 includes the third printing unit 58 and the second printing unit 66 that are positioned upstream and downstream of the first printing unit 65, the present disclosure is not limited to this configuration, and a printing unit may be arranged at least one side. In other words, the printing apparatus 100 includes the second printing unit 66 held by the carriage 62 and arranged at least one of a position further upstream and a position further downstream than that of the first printing unit 65.

The third printing unit 58 ejects a pretreatment liquid and the like for pretreatment that improves permeability and fixability of the first ink in the medium P. As the pretreatment liquid, a treatment liquid using urea, which is a component having a large dipole moment, is preferably used as a polar material. Note that the treatment liquid is not limited to the treatment liquid using urea, and ethylene glycol, ethanol, 2-propanol, 1-propanol, dimethyl sulfoxide, dimethylformamide, acetone, ethyl acetate, methanol, acetic acid, tetrahydrofuran, pyridine, dichloromethane, acetic anhydride, diethyl ether, trimethylamine, cyclohexane, xylene, hexane, benzene, toluene, n-pentane, ethylene urea, or the like may be used.

In addition, the pretreatment liquid is not limited thereto, and when a color tone of the fabric of the medium P is a dark color tone such as black, white printing (solid printing) by using white ink may be performed. Since the printing unit is a solenoid valve type, ejection of a larger amount and ejection of a liquid having a higher viscosity than those of the first printing unit 65 can be handled.

As described above, the printing apparatus 100 according to the present embodiment can achieve the following advantages.

The printing apparatus 100 includes the second printing unit 66 held by the carriage 62 and arranged at least one of a position further upstream and a position further downstream than that of the first printing unit 65. In a preferred example, the printing head 68 includes the third printing unit 58 and the second printing unit 66 that are positioned upstream and downstream of the first printing unit 65.

According to this, since printing with the first ink is performed on the medium P after the treatment with the pretreatment liquid is performed on the medium P, and then, post-treatment with the second ink is performed, clear and firm printing can be performed.

As a result, the printing apparatus 100 being capable of overlapping printing of a plurality of types of ink, obtaining clear and firm printing, and having a small size can be provided.

### Embodiment 4

### Another Printing Mode of Second Printing Unit

In addition to the mode in which the second printing unit 66 reduces the ejection amount for one scanning pass as the number of scanning passes increases, for example, when the first printing unit 65 performs eight scanning passes of printing, the second printing unit 66 may perform 100% of ejection without reducing the amount of ink to be ejected in one scanning pass to ⅛. This causes printing with a density higher than that to be normally required. Further, the number of scanning passes may be determined from the density necessary for printing from the necessary second printing unit.

What is claimed is:

1. A printing apparatus comprising:
a transport unit configured to transport a medium in a first direction;
a carriage configured to move in a second direction intersecting the first direction;
a first printing unit held by the carriage; and
a second printing unit held by the carriage, the second printing unit being arranged at least one of a position further upstream and a position further downstream than a position of the first printing unit, wherein
a length of the second printing unit in the first direction is shorter than a length of the first printing unit in the first direction, and
the second printing unit is caused to be available in a multi-pass mode.

2. The printing apparatus according to claim 1, wherein
the second printing unit includes a solenoid valve type of an ejecting head including a plurality of solenoid valves.

3. The printing apparatus according to claim 2, wherein
the ejecting head is arranged in an inclined manner with respect to the second direction.

4. The printing apparatus according to claim 2, wherein
a plurality of the second printing units are arranged in the second direction.

5. The printing apparatus according to claim 1, wherein
the second printing unit reduces an ejection amount for one pass as the number of scanning passes increases.

6. A printing method by using a printing apparatus, the printing apparatus including
a control unit,
a transport unit configured to transport a medium in a first direction,
a carriage configured to move in a second direction intersecting the first direction,
a first printing unit held by the carriage, and
a second printing unit held by the carriage, the second printing unit being arranged at least one of a position further upstream and a position further downstream than a position of the first printing unit, wherein
a length of the second printing unit in the first direction is shorter than a length of the first printing unit in the first direction, and
the control unit causes the second printing unit to be available when a printing mode of the printing apparatus is a multi-pass mode.
